(19) United States
(12) Patent Application Publication
(10) Pub. No.: US 2026/0135764 A1
(43) Pub. Date: May 14, 2026

(54) METHOD AND APPARATUS FOR NETWORK CONTROLLED RELAY IN COMMUNICATION SYSTEM

(71) Applicant: Electronics and Telecommunications Research Institute, Daejeon (KR)

(72) Inventor: Hyung Sik JU, Daejeon (KR)

(21) Appl. No.: 19/383,472

(22) Filed: Nov. 7, 2025

(30) Foreign Application Priority Data
Nov. 12, 2024 (KR) 10-2024-0160340
Oct. 16, 2025 (KR) 10-2025-0150111

(51) Int. Cl. H04L 41/0895; H04B 7/06; H04L 5/00; H04L 69/323

(52) U.S. Cl. CPC H04L 41/0895; H04B 7/06952; H04L 5/0007; H04L 69/323

(57) ABSTRACT

A method of a network controlled repeater (NCR) may comprise: configuring a processor to generate a plurality of protocol stack entities through virtualization; allocating time durations to the protocol stack entities based on a time domain parameter; generating a plurality of virtual NCRs by using at least one modem operating based on the protocol stack entities and the time durations; and providing, by using each of the plurality of virtual NCRs, a communication service to each terminal through an access link beam according to an access link beam indication from a base station.

### CROSS-REFERENCE TO RELATED APPLICATIONS

This application claims priority to Korean Patent Applications No. 10-2024-0160340, filed on November 12, 2024, and No. 10-2025-0150111, filed on October 16, 2025, with the Korean Intellectual Property Office (KIPO), the entire contents of which are hereby incorporated by reference.

### BACKGROUND

### 1. Technical Field

The present disclosure relates to a network-controlled relaying technique in a communication system, and more particularly, to a network-controlled relaying technique for supporting multiple access link beams on an access link.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G)

communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In such a communication system, mobile network operators may consider different types of network nodes to increase coverage flexibility for network deployment. For example, a network node may be an integrated access and backhaul (IAB). As another example, a network node may be a radio frequency (RF) repeater. The RF repeater can amplify and forward a received signal. As yet another example, a network node may be a network controlled repeater (NCR). The NCR can receive side control information from a network and operate based on the side control information, thereby providing enhanced functionality compared to the RF repeater. The NCR can support one beam on an access link. The NCR may need the capabilities to support multiple beams on the access link to improve performance according to various service scenarios and the introduction of NCR.

### SUMMARY

The present disclosure for resolving the above-described problems is directed to providing methods and apparatuses for network-controlled relaying to support multiple access link beams on an access link.

According to a first exemplary embodiment of the present disclosure, a method of a network controlled repeater (NCR) may comprise: configuring a processor to generate a plurality of protocol stack entities through virtualization; allocating time durations to the protocol stack entities based on a time domain parameter; generating a plurality of virtual NCRs by using at least one modem operating based on the protocol stack entities and the time durations; and providing, by using each of the plurality of virtual NCRs, a communication service to each terminal through an access link beam according to an access link beam indication from a base station.

The virtualization may be based on Kubernetes.

The allocating of the time durations to the protocol stack entities may comprise: determining the time domain parameter based on at least one of an orthogonal frequency division multiplexing (OFDM) symbol duration or a slot duration; determining a basic time duration based on the time domain parameter; time-dividing the basic time duration to determine the time durations; and allocating each of the time durations to each of the protocol stack entities.

The at least one modem may operate based on a clock signal corresponding to an integer multiple frequency of a channel bandwidth.

The providing of the communication service to each terminal may comprise: receiving, from the base station, a specific radio network temporary identifier (RNTI) for each of the generated plurality of virtual NCRs; receiving, from the base station, the access link beam indication for each of the plurality of virtual NCRs based on the specific RNTI; and providing, by using each of the plurality of virtual NCRs, the communication service to each terminal through the access link beam based on the access link beam indication.

The receiving of the specific RNTI for each of the generated plurality of virtual NCRs may comprise: transmitting, to the base station, a preamble sequentially by using each of the plurality of virtual NCRs; and receiving, from the base station, the specific RNTI for each of the plurality of virtual NCRs.

The transmitting of the preamble sequentially by using each of the plurality of virtual NCRs may comprise: assigning an order to each of the plurality of virtual NCRs; and transmitting, to the base station, the preamble by using each of the plurality of virtual NCRs according to the assigned order.

Each of the protocol stack entities may perform a function of at least one layer among a medium access control (MAC) layer, a radio link control (RLC) layer, a packet data convergence protocol (PDCP) layer, a radio resource control (RRC) layer, a non-access stratum (NAS) layer, and an upper part of a physical (PHY) layer.

According to a second exemplary embodiment of the present disclosure, a method of a base station may comprise: providing, to each of a plurality of virtual network control repeaters (NCRs) virtualized from an NCR, a specific radio network temporary identifier (RNTI) through a random access procedure; transmitting, to each of the plurality of virtual NCRs, an access link beam indication based on the specific RNTI; and providing, to each of the plurality of virtual NCRs, data to be transmitted using an access link beam according to the access link beam indication.

The providing of the specific RNTI may comprise: receiving, from each of the plurality of virtual NCRs, a preamble; and providing, to each of the plurality of virtual NCRs, the specific RNTI.

In the transmitting of the access link beam indication based on the specific RNTI, the base station may transmit the access link beam indication instructing use of the access link beam in at least one of a symbol unit or a slot unit.

According to a third exemplary embodiment of the present disclosure, a network controller repeater (NCR) may comprise at least one processor, and the at least one processor may cause the NCR to perform: generating a plurality of protocol stack entities through virtualization; allocating time durations to the protocol stack entities based on a time domain parameter; generating a plurality of virtual NCRs by using at least one modem operating based on the protocol stack entities and the time durations; and providing, by using each of the plurality of virtual NCRs, a communication service to each terminal through an access link beam according to an access link beam indication from a base station.

The virtualization may be based on Kubernetes.

In the allocating of the time durations to the protocol stack entities, the at least one processor may cause the NCR to perform: determining the time domain parameter based on at least one of an orthogonal frequency division multiplexing (OFDM) symbol duration or a slot duration; determining a basic time duration based on the time domain parameter; time-dividing the basic time duration to determine the time durations; and allocating each of the time durations to each of the protocol stack entities.

The at least one modem may operate based on a clock signal corresponding to an integer multiple frequency of a channel bandwidth.

In the providing of the communication service to each terminal, the at least one processor may cause the NCR to perform: receiving, from the base station, a specific radio network temporary identifier (RNTI) for each of the generated plurality of virtual NCRs; receiving, from the base station, the access link beam indication for each of the plurality of virtual NCRs based on the specific RNTI; and providing, by using each of the plurality of virtual NCRs, the communication service to each terminal through the access link beam based on the access link beam indication.

In the receiving of the specific RNTI for each of the generated plurality of virtual NCRs, the at least one processor may cause the NCR to perform: transmitting, to the base station, a preamble sequentially by using each of the plurality of virtual NCRs; and receiving, from the base station, the specific RNTI for each of the plurality of virtual NCRs.

Each of the protocol stack entities may perform a function of at least one layer among a medium access control (MAC) layer, a radio link control (RLC) layer, a packet data convergence protocol (PDCP) layer, a radio resource control (RRC) layer, a non-access stratum (NAS) layer, and an upper part of a physical (PHY) layer.

According to the present disclosure, an NCR can form a plurality of virtual NCRs through virtualization. The plurality of virtual NCRs can operate independently and can individually receive access link beam indications from a base station. Accordingly, the NCR can generate a plurality of access link beams through the virtual NCRs and can provide communication services to a plurality of terminals through the generated access link beams. As a result, the NCR can efficiently provide communication services to the plurality of terminals.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a communication system supporting a network controlled repeater.

FIG. 4 is a block diagram illustrating exemplary embodiments of a network controlled repeater.

FIG. 5 is a conceptual diagram illustrating exemplary embodiments of an operation method of a modem.

FIG. 6 is a conceptual diagram illustrating exemplary embodiments of an operation method of a modem.

FIG. 7 is a conceptual diagram illustrating exemplary embodiments of a network-controlled relaying method in a communication system.

FIG. 8 is a flowchart illustrating exemplary embodiments of a network-controlled relaying method in a communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In the present disclosure, a phrase including “when ~” may be expressed as a phrase including “based on ~” or a phrase including “in response to ~”. In other words, a phrase including “when ~” may be interpreted as the same as or similar to a phrase including “based on ~” or a phrase including “in response to ~”.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments according to the present disclosure will be described with respect to a communication system to which the exemplary embodiments are applied. The communication system to which the exemplary embodiments according to the present disclosure are applied is not limited to the content described below, and the exemplary embodiments according to the present disclosure may be applied to various communication systems. Here, the communication system may be used in the same sense as a communication network.

Throughout the present disclosure, a network may include, for example, wireless Internet such as wireless fidelity (WiFi), portable Internet such as wireless broadband internet (WiBro) or world interoperability for microwave access (WiMax), a 2G mobile communication network such as global system for mobile communication (GSM) or code division multiple access (CDMA), a 3G mobile communication network such as wideband code division multiple access (WCDMA) or CDMA2000, a 3.5G mobile communication network such as high speed downlink packet access (HSDPA) or high speed uplink packet access (HSUPA), a 4G mobile communication network such as long term evolution (LTE) network or LTE-Advanced network, a 5G mobile communication network, and a 6G mobile communication network.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, a base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

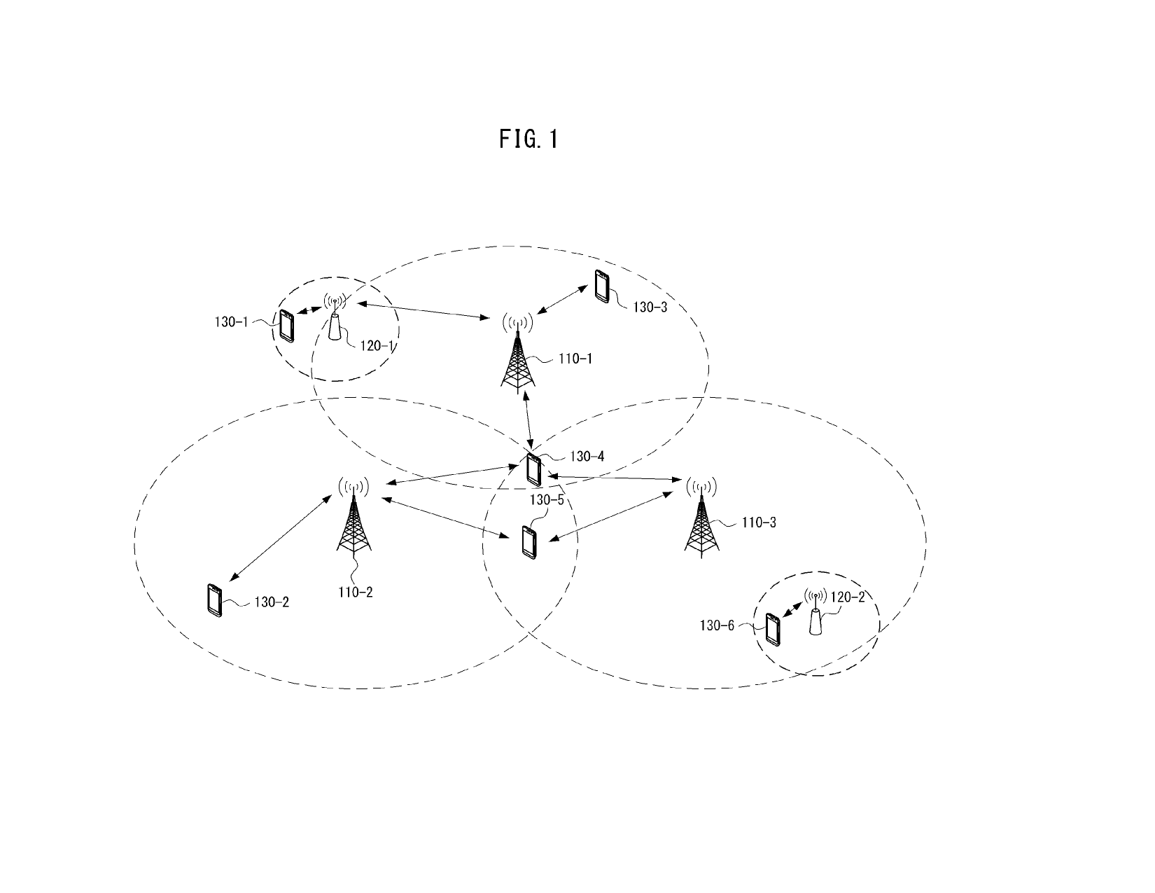

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6GHz, and the 5G communication may be performed in frequency bands above 6GHz as well as frequency bands below 6GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

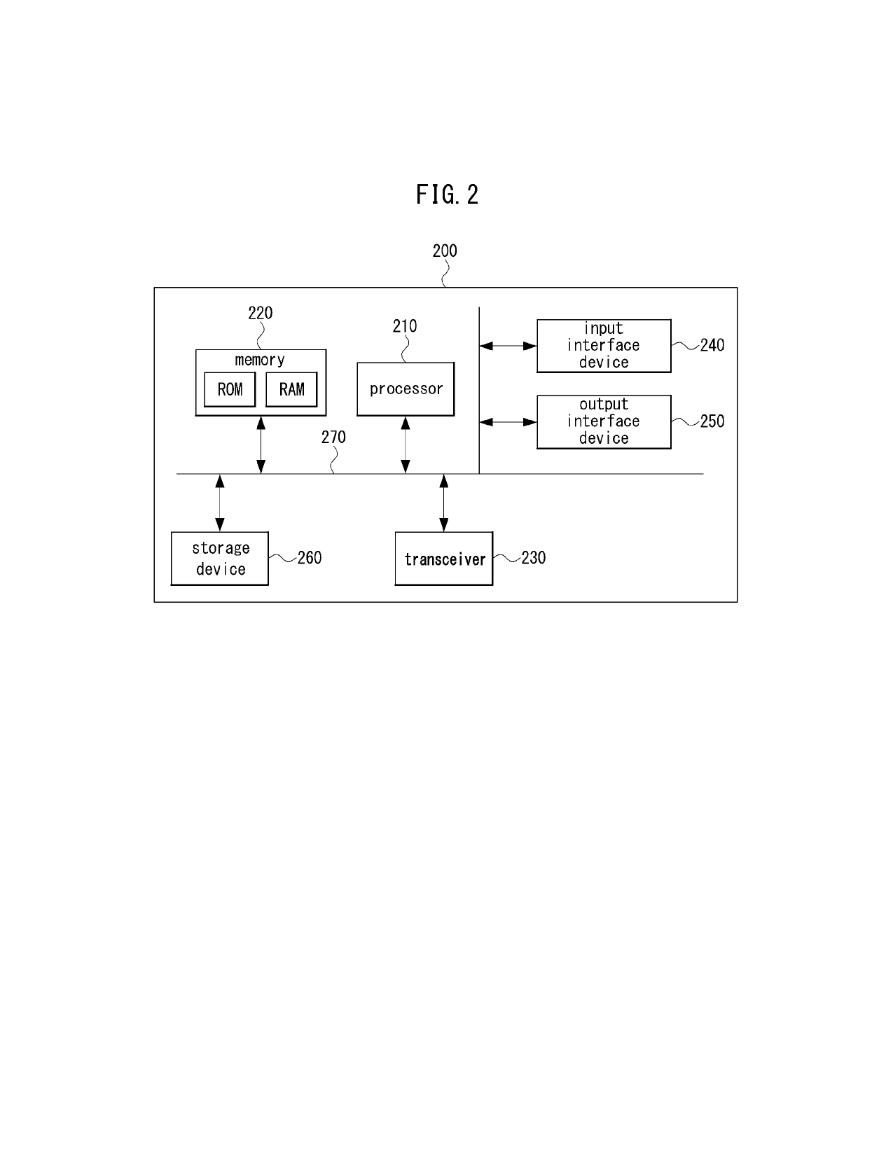

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

In a communication system, wireless communication coverage may be a fundamental aspect of cellular network deployments, and mobile network operators may rely on different types of network nodes to facilitate comprehensive coverage of wireless communication system deployments. The deployment of regular full-stack cells may be one option, but due to the lack of backhaul availability, such deployment may not always be possible and may not be economically feasible. Consequently, mobile network operators may consider different types of network nodes to enhance flexibility in network deployment coverage.

One type of network node may be an integrated access and backhaul (IAB). The IAB may be a new type of network node that does not require a wired backhaul. Another type of network node may be a radio frequency (RF) repeater. The RF repeater may amplify and forward a received signal. The RF repeater may provide a cost-effective solution for extending network coverage. However, since the RF repeater simply performs amplify-and-forward operations, the RF repeater may have performance limitations. Various control elements that may improve the performance of the RF repeater may include information on downlink/uplink configuration, adaptive transceiver spatial beamforming, and ON-OFF state.

Yet another type of network node may be a network controlled repeater (NCR). The NCR may receive side control information from a network and operate based on the side control information, thereby providing improved functionality compared to the RF repeater. Here, the side control information may enable the network controlled repeater to perform amplify-and-forward operations in an efficient manner. Such a network controlled repeater may provide mitigation of unnecessary noise amplification, better spatially directed transmission and reception, and simplified network integration.

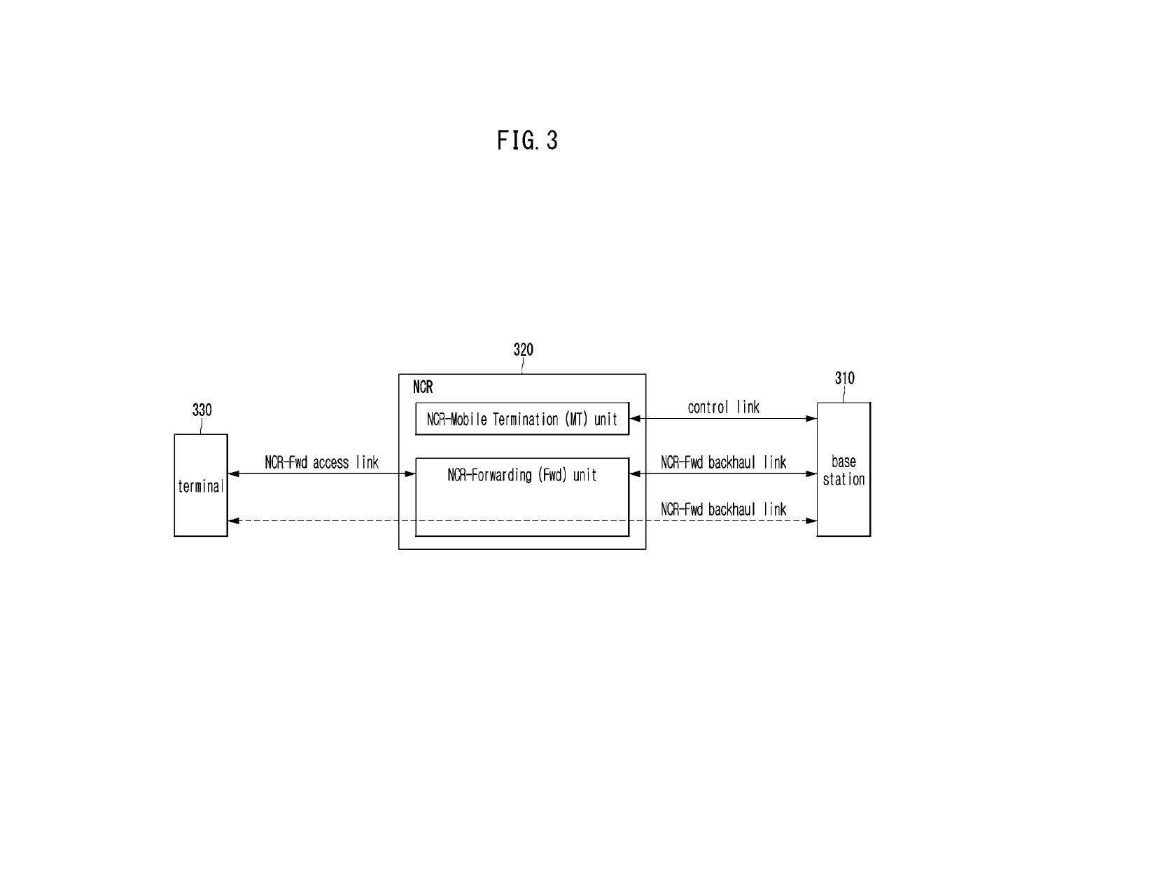

FIG. 3 is a conceptual diagram illustrating exemplary embodiments of a communication system supporting a network controlled repeater.

Referring to FIG. 3, a communication system may include a base station 310, an NCR 320, and a terminal 330. The network controlled repeater 320 may communicate with the base station 310. The network controlled repeater 320 may communicate with the terminal 330.

The NCR 320 may include an NCR-mobile termination (MT) unit and an NCR-forwarding (Fwd) unit (i.e. RF forwarding unit). The NCR-MT unit may be a functional entity that communicates with the base station 310 through a control link (C-link) to enable exchange of control information. The control information may be side control information (SCI) for controlling the NCR-Fwd unit. The control link may be based on a Uu interface of NR. The SCI is not limited to the terms described in the present disclosure and may use other terms having equivalent technical meanings, such as repeater-downlink control information (R-DCI), repeater control information (RCI), or network controlled repeater control information (NCI).

The NCR-Fwd unit may be a functional entity capable of amplifying and forwarding uplink (UL)/downlink (DL) RF signals between the base station 310 and the terminal 330 through an NCR-Fwd backhaul link and an NCR-Fwd access link. The NCR 320 may control operations of the NCR-Fwd unit according to SCI received from the base station 310.

In terms of repeater management, the NCR 320 may connect to the base station 310 according to a terminal access procedure of NR. The NCR-MT unit may establish a signaling radio bearer (SRB) between the NCR-MT unit and the base station 310. The NCR-MT unit may optionally establish a data radio bearer (DRB) between the NCR-MT unit and the base station 310. The established DRB may be used for transmitting operations, administration and management (OAM) traffic.

The NCR 320 may relay communication (e.g. DL and/or UL communication) between the base station 310 and the terminal 330. In case of downlink, the NCR 320 may receive a DL signal from the base station 310 and perform an operation of amplifying and forwarding the DL signal to the terminal 330. In case of uplink, the NCR 320 may receive a UL signal from the terminal 330 and perform an operation of amplifying and forwarding the UL signal to the base station 310.

According to NR Release 18 of 3GPP, the NCR may support one beam in a given time-frequency resource on an access link (e.g. NCR-terminal link). The NCR may need a capability to support a plurality of access link beams in a given time-frequency resource of the access link in order to improve performance associated with various service scenarios and the introduction of the NCR. The present disclosure provides a configuration and an operation method of the NCR capable of supporting a plurality of access link beams in a given time-frequency resource.

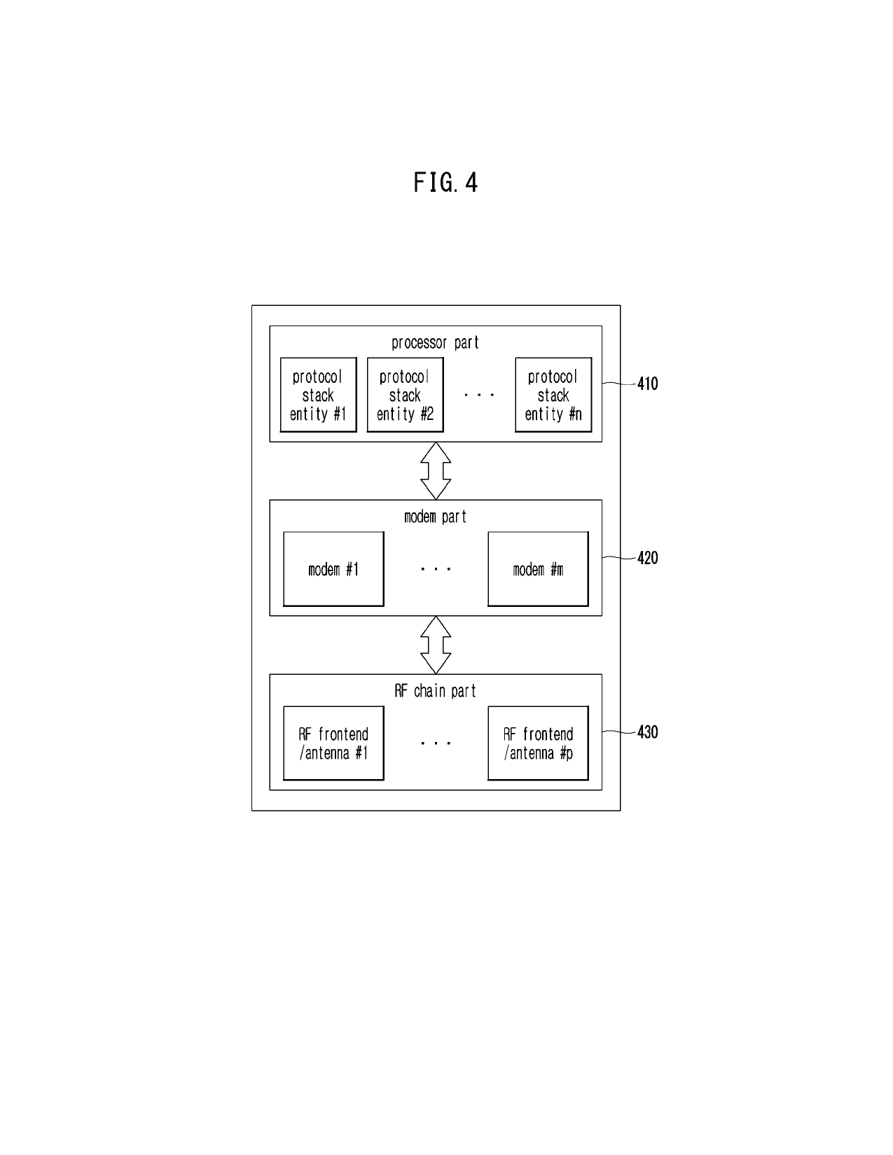

FIG. 4 is a block diagram illustrating exemplary embodiments of a network controlled repeater.

Referring to FIG. 4, an NCR may include a processor part 410 comprising one or more processors, a modem part 420 comprising one or more modems (i.e. modem #1 to modem #m), and an RF chain part 430 comprising one or more RF front ends/antenna panels (i.e. RF front end/antenna #1, …, and RF front end/antenna #p). n, m, and p may be positive integers.

The processor may be a central processing unit (CPU), a neural processing unit (NPU), or the like. The processor part may form and operate a plurality of virtual independent protocol stack entities (i.e. protocol stack entity #1 to protocol stack entity #n) based on Kubernetes. The protocol stack entity may refer to protocol software including a network layer from a medium access control (MAC) layer to a non-access stratum (NAS) layer. In other words, the protocol stack entity may perform a function of at least one layer among a MAC layer, a radio link control (RLC) layer, a packet data convergence protocol (PDCP) layer, a radio resource control (RRC) layer, or a NAS layer. The protocol stack entity may perform a function of an upper part (i.e. PHY-upper) of a physical (PHY) layer.

The NCR may independently operate each of the protocol stack entities. Accordingly, a base station (e.g. gNB) may recognize each of the protocol stack entities operating in the NCR as a protocol stack entity of a different NCR.

The modem part may comprise one or more modems. Each of the modems may be configured as a field-programmable gate array (FPGA) or an application specific integrated circuit (ASIC) chip. The modem may support all or part of functions of the PHY layer. For example, the modem may include a lower part (PHY-lower) of the PHY layer including orthogonal frequency division multiplexing (OFDM) modulation/demodulation, resource element (RE) mapping/de-mapping, and an RF part, and the protocol stack entity may have the remaining upper part (PHY-upper) of the PHY layer. Alternatively, the modem may perform the entire function of the PHY layer.

Some of the modems may perform the function of the lower part (PHY-lower) of the PHY layer. Other modems may perform the function of the upper part (PHY-upper) of the PHY layer. Still other modems may perform the entire function of the PHY layer.

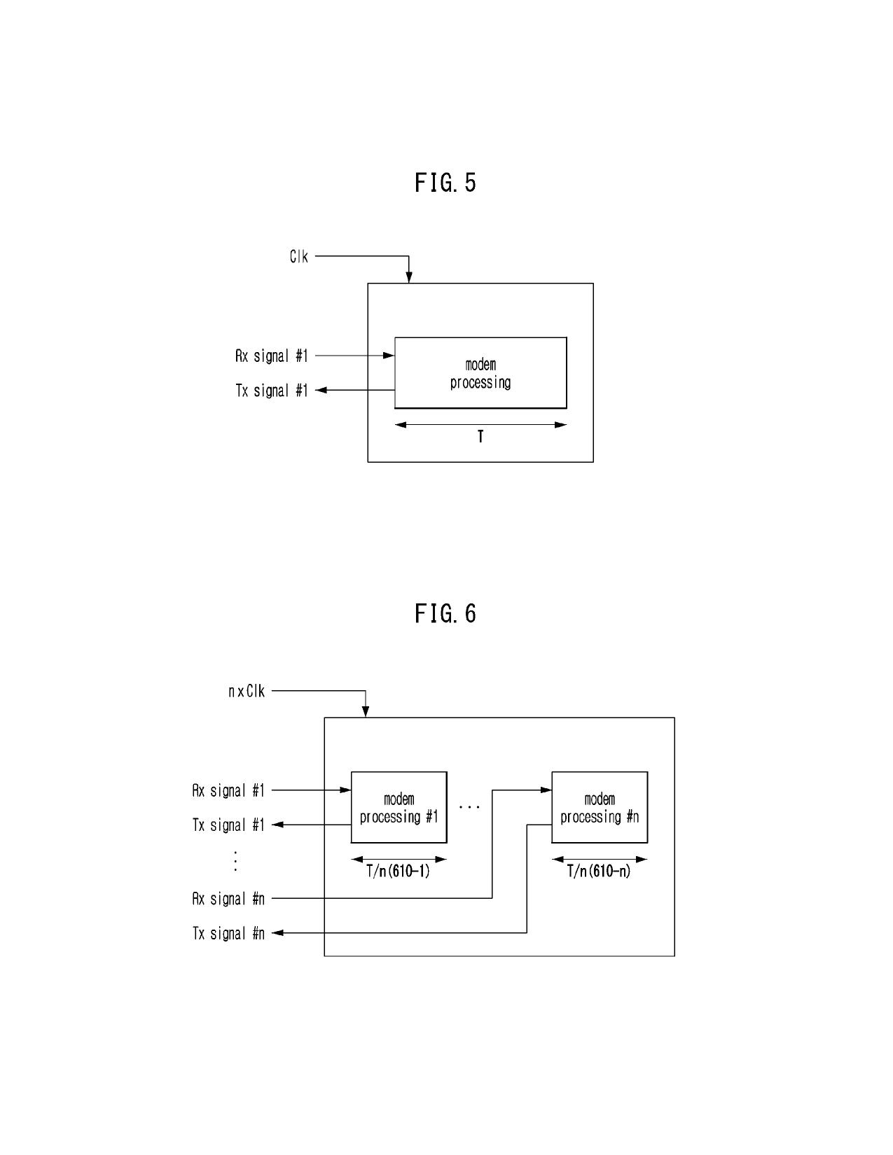

FIG. 5 is a conceptual diagram illustrating exemplary embodiments of an operation method of a modem.

Referring to FIG. 5, a modem may receive, from a clock generator, a first clock signal Clk having a first frequency determined based on a channel bandwidth. The modem may operate based on the first clock signal. The modem may transmit a transmission (Tx) signal (Tx signal #1) during a time duration of T and may perform modem processing for receiving a reception (Rx) signal (Rx signal #1).

Alternatively, the modem may receive a reception signal (Rx signal #1) during a time duration of T and may perform modem processing for transmitting a transmission signal (Tx signal #1). The length T of the time duration may be determined by a time domain parameter (e.g. a symbol duration or a slot duration) of the 5G NR standard.

FIG. 6 is a conceptual diagram illustrating exemplary embodiments of an operation method of a modem.

Referring to FIG. 6, a modem may receive, from a clock generator, a second clock signal n×Clk having a second frequency determined based on the channel bandwidth. The second frequency may be n times the first frequency. n may be a positive integer and may represent the number of protocol stack entities. The modem may operate based on the second clock signal.

The modem may transmit a transmission (Tx) signal (Tx signal #1) during a first sub-time duration of T/n 610 and may perform modem processing #1 for receiving a reception (Rx) signal (Rx signal #1). Alternatively, the modem may receive a reception signal (Rx signal #1) during a first sub-time duration of T/n and may perform modem processing #1 for transmitting a transmission signal (Tx signal #1). In the above-described manner, the modem may sequentially perform modem processing.

The modem may transmit a transmission signal (Tx signal #n) during an n-th sub-time duration of T/n 620 and may perform modem processing #n for receiving a reception signal (Rx signal #n). Alternatively, the modem may receive a reception signal (Rx signal #n) during an n-th sub-time duration of T/n and may perform modem processing #n for transmitting a transmission signal (Tx signal #n).

The modem may transmit n transmission signals (Tx signal #1 to Tx signal #n) and may perform modem processing #1 to modem processing #n for receiving n reception signals (Rx signal #1 to Rx signal #n) during a time duration of T. Alternatively, the modem may receive n reception signals (Rx signal #1 to Rx signal #n) and may perform modem processing #1 to modem processing #n for transmitting n transmission signals (Tx signal #1 to Tx signal #n) during a time duration of T. The length T of the time duration may be determined by a time domain parameter (e.g. a symbol duration or a slot duration) of the 5G standard. As described above, each of the modems may be over-clocked relative to the channel bandwidth. In other words, the modem may virtually operate as n modems by using a second clock signal whose frequency is n times higher than that of the first clock signal.

The modem may perform the function of the lower part (PHY-lower) of the PHY layer during some of the sub-time durations. The modem may perform the function of the upper part (PHY-upper) of the PHY layer during other sub-time durations. The modem may perform a whole function of the PHY layer during still other sub-time durations.

The modem may support some protocol stack entities during some of the sub-time durations. The modem may support other protocol stack entities during other sub-time durations. The modem may support still other protocol stack entities during still other sub-time durations.

Referring again to FIG. 4, the RF chain part may include the RF front end/antenna #1 to the RF front end/antenna #p. Each RF front end/antenna may form one beam. Accordingly, the RF front ends/antennas may form multiple beams. The modem may form one beam by using each

RF front end/antenna. Accordingly, the modem may form multiple beams by using the RF front ends/antennas.

Two more RF front ends/antennas may form one beam. Accordingly, some of the RF front ends/antennas may form multiple beams. The modem may form one beam by using two or more RF front ends/antennas. Accordingly, the modem may form multiple beams by using some of the RF front ends/antennas.

Two or more of the RF front ends/antennas may form one beam. Accordingly, two or more pairs of the RF front ends and antennas may form multiple beams. The modem may form one beam by using two or more RF front ends/antennas. Accordingly, the modem may form multiple beams by using two or more RF front ends/antennas. In the above-described manner, the modem may use different RF front ends/antennas or a portion of one RF front end/antenna to form different beams.

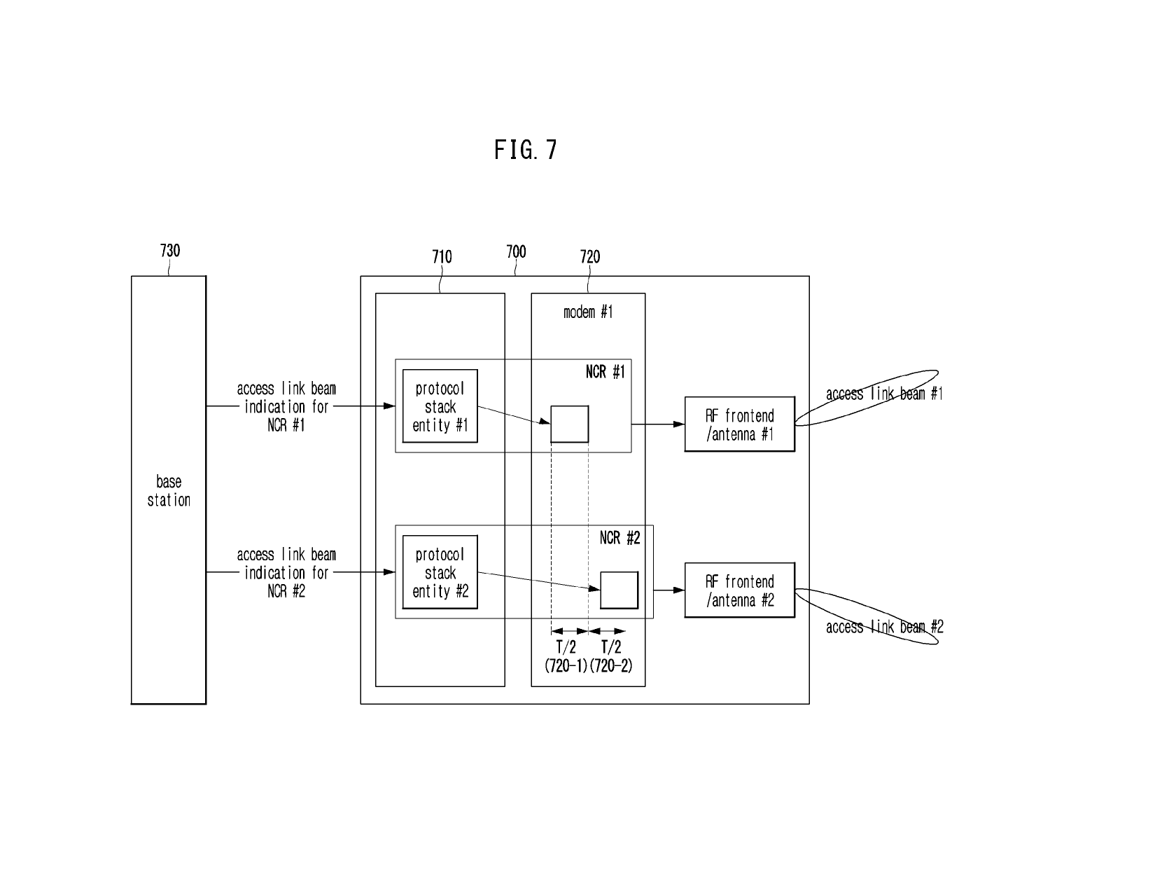

FIG. 7 is a conceptual diagram illustrating exemplary embodiments of a network-controlled relaying method in a communication system.

Referring to FIG. 7, a processor 710 of an NCR 700 may form and operate multiple protocol stack entities through virtualization based on Kubernetes. For example, the processor may form and operate a protocol stack entity #1 and a protocol stack entity #2 through virtualization.

The NCR may include a modem part 720 composed of one or more modems. For example, the modem part 720 may include one modem #1. The processor of the NCR may determine a first frequency based on a channel bandwidth. A clock signal having the first frequency may be a first clock signal. For example, the processor of the NCR may determine the first frequency based on a channel bandwidth of the modem #1. The processor may determine a second frequency that is an integer multiple of the first frequency and may operate the modem based on a second clock signal having the determined second frequency. For example, the second frequency may be twice the first frequency. A clock generator may generate the second clock signal and provide the second clock signal to the modem. The modem may receive the second clock signal from the clock generator and may operate based on the received second clock signal.

The processor of the NCR may determine a basic time duration based on a time domain parameter defined by the 5G standard. For example, the processor of the NCR may determine a basic time duration of T based on a time domain parameter defined by the 5G standard. T may be a real number.

The processor may divide the basic time duration in time and determine multiple sub-time durations. For example, the processor may equally divide the basic time duration of T into a first sub-time duration of T/2 720-1 and a second sub-time duration of T/2 720-2.

The processor may enable the modem to support different protocol stack entities in respective sub-time durations. For example, the processor may enable the modem to support the protocol stack entity #1 during the first sub-time duration. The processor may enable the modem to support the protocol stack entity #2 during the second sub-time duration. In the above-described manner, the processor may enable the modem to virtually operate as multiple modems by using the second clock signal having a frequency that is an integer multiple of the first frequency and by dividing and using the basic time duration in time.

The processor may enable one of protocol stack entities and the modem to form one virtual NCR in each of sub-time durations. For example, the processor may enable the protocol stack entity #1 and the modem #1 to form a virtual NCR #1 in the first sub-time duration. The processor may enable the protocol stack entity #2 and the modem #1 to form a virtual NCR #2 in the second sub-time duration.

The processor may enable the virtual NCR to provide a communication service to a terminal by forming a beam through use of an RF front end/antenna. For example, the processor may enable the virtual NCR #1 to form an access link beam #1 by using an RF front end/antenna #1. The processor may provide a communication service to a terminal #1 by using the formed access link beam #1. The processor may enable the virtual NCR #2 to form an access link beam #2 by using an RF front end/antenna #2. The processor may provide a communication service to a terminal #2 by using the formed access link beam #2.

The base station 730 may recognize each of the virtual NCRs as one NCR. The base station may assign a specific radio network temporary identifier (RNTI) to each of the virtual NCRs.

For example, the processor may assign an order to each of the virtual NCRs. Each of the virtual NCRs may sequentially transmit a preamble to the base station according to the assigned order. The base station may receive the preamble from each of the virtual NCRs. The base station may assign a temporary cell radio network temporary identifier (TC-RNTI) and may transmit, to each of the virtual NCRs, a random access response (RAR) including uplink grant allocation information such as NCR identifier information, timing information, and resource allocation information. Each of the virtual NCRs may receive, from the base station, the random access response including uplink grant allocation information such as NCR identifier information, timing information, and resource allocation information and may obtain a specific RNTI (i.e. C-RNTI).

The base station may indicate an access link beam to each of the virtual NCRs. The base station may transmit the access link beam indication instructing the use of the access link beam in symbol units or slot units. When the base station provides the access link beam indication in symbol units, the base station may indicate symbol-level time resources of a slot indicated by a slot offset and may indicate the access link beam to be applied in the time resources. The symbol-level time resources may have different start symbols and lengths. Each of the virtual NCRs may receive, from the base station, the slot offset and the indication of the symbol-level time resources and may generate the access link beam in the symbol-level time resources corresponding to the received slot offset.

When the base station provides the access link beam indication in slot units, the base station may indicate a number of consecutive slots starting from a start slot indicated by a slot offset and may indicate the access link beam to be applied to the slots. When a plurality of slot offsets and numbers of consecutive slots are indicated, each of the virtual NCRs may receive time-division indication for one or more beams in slot units. Each of the virtual NCRs may receive, from the base station, the slot offset and the number of consecutive slots and may generate an access link beam starting from a slot corresponding to the received slot offset.

Each of the virtual NCRs may receive an access link beam indication from the base station. Each of the virtual NCRs may generate an access link beam based on the access link beam indication received from the base station. Each of the virtual NCRs may provide a communication service to a terminal by using the generated access link beam.

For example, the base station may assign an RNTI #1 to a virtual NCR #1. The base station may assign an RNTI #2 to a virtual NCR #2. The base station may indicate an access link beam #1 to the virtual NCR #1. The base station may indicate an access link beam #2 to the virtual NCR #2. The virtual NCR #1 may receive, from the base station, the indication of the access link beam #1. The virtual NCR #2 may receive, from the base station, the indication of the access link beam #2. The virtual NCR #1 may provide a communication service to a terminal #1 by using the access link beam #1 according to the indication of the access link beam #1 received from the base station. The virtual NCR #2 may provide a communication service to a terminal #2 by using the access link beam #2 according to the indication of the access link beam #2 received from the base station.

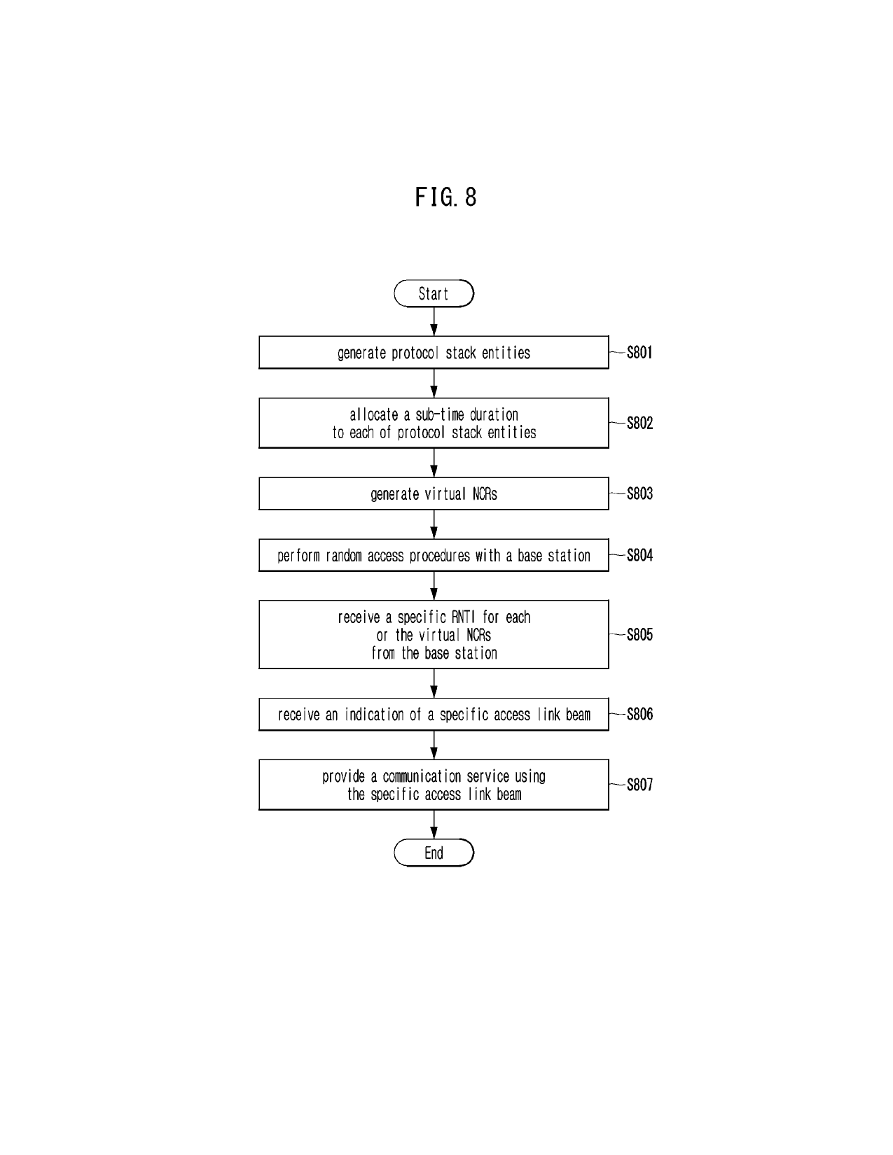

FIG. 8 is a flowchart illustrating exemplary embodiments of a network-controlled relaying method in a communication system.

Referring to FIG. 8, an NCR may generate multiple protocol stack entities through virtualization (S801). The NCR may allocate a sub-time duration to each of the multiple protocol stack entities (S802). The NCR may enable a modem to support the respective protocol stack entities in the respective sub-time durations. Through this process, the NCR may form multiple virtual NCRs by using the multiple protocol stack entities and the modem operating based on the sub-time durations (S803).

Each of the virtual NCRs may perform a random access procedure with a base station (S804). The base station may assign a specific RNTI to each of the virtual NCRs. Each of the virtual NCRs may receive a specific RNTI from the base station (S805). The base station may provide a specific access link beam indication to each of the virtual NCRs. Each of the virtual NCRs may receive the specific access link beam indication from the base station (S806). Each of the virtual NCRs may provide a communication service to a corresponding terminal by using an access link beam based on the specific access link beam indication (S807).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a network controlled repeater (NCR), comprising:
configuring a processor to generate a plurality of protocol stack entities through virtualization;
allocating time durations to the protocol stack entities based on a time domain parameter;
generating a plurality of virtual NCRs by using at least one modem operating based on the protocol stack entities and the time durations; and
providing, by using each of the plurality of virtual NCRs, a communication service to each terminal through an access link beam according to an access link beam indication from a base station.

2. The method of claim 1, wherein the virtualization is based on Kubernetes.

3. The method of claim 1, wherein the allocating of the time durations to the protocol stack entities comprises:
determining the time domain parameter based on at least one of an orthogonal frequency division multiplexing (OFDM) symbol duration or a slot duration;
determining a basic time duration based on the time domain parameter;
time-dividing the basic time duration to determine the time durations; and
allocating each of the time durations to each of the protocol stack entities.

4. The method of claim 1, wherein the at least one modem operates based on a clock signal corresponding to an integer multiple frequency of a channel bandwidth.

5. The method of claim 1, wherein the providing of the communication service to each terminal comprises:
receiving, from the base station, a specific radio network temporary identifier (RNTI) for each of the generated plurality of virtual NCRs;
receiving, from the base station, the access link beam indication for each of the plurality of virtual NCRs based on the specific RNTI; and
providing, by using each of the plurality of virtual NCRs, the communication service to each terminal through the access link beam based on the access link beam indication.

6. The method of claim 5, wherein the receiving of the specific RNTI for each of the generated plurality of virtual NCRs comprises:
transmitting, to the base station, a preamble sequentially by using each of the plurality of virtual NCRs; and
receiving, from the base station, the specific RNTI for each of the plurality of virtual NCRs.

7. The method of claim 6, wherein the transmitting of the preamble sequentially by using each of the plurality of virtual NCRs comprises:
assigning an order to each of the plurality of virtual NCRs; and
transmitting, to the base station, the preamble by using each of the plurality of virtual NCRs according to the assigned order.

8. The method of claim 1, wherein each of the protocol stack entities performs a function of at least one layer among a medium access control (MAC) layer, a radio link control (RLC) layer, a packet data convergence protocol (PDCP) layer, a radio resource control (RRC) layer, a non-access stratum (NAS) layer, and an upper part of a physical (PHY) layer.

9. A method of a base station, comprising:
providing, to each of a plurality of virtual network control repeaters (NCRs) virtualized from an NCR, a specific radio network temporary identifier (RNTI) through a random access procedure;
transmitting, to each of the plurality of virtual NCRs, an access link beam indication based on the specific RNTI; and
providing, to each of the plurality of virtual NCRs, data to be transmitted using an access link beam according to the access link beam indication.

10. The method of claim 9, wherein the providing of the specific RNTI comprises:
receiving, from each of the plurality of virtual NCRs, a preamble; and
providing, to each of the plurality of virtual NCRs, the specific RNTI.

11. The method of claim 9, wherein in the transmitting of the access link beam indication based on the specific RNTI, the base station transmits the access link beam indication instructing use of the access link beam in at least one of a symbol unit or a slot unit.

12. A network controller repeater (NCR) comprising at least one processor, wherein the at least one processor causes the NCR to perform:
generating a plurality of protocol stack entities through virtualization;
allocating time durations to the protocol stack entities based on a time domain parameter;
generating a plurality of virtual NCRs by using at least one modem operating based on the protocol stack entities and the time durations; and
providing, by using each of the plurality of virtual NCRs, a communication service to each terminal through an access link beam according to an access link beam indication from a base station.

13. The NCR of claim 12, wherein the virtualization is based on Kubernetes.

14. The NCR of claim 12, wherein in the allocating of the time durations to the protocol stack entities, the at least one processor causes the NCR to perform:
determining the time domain parameter based on at least one of an orthogonal frequency division multiplexing (OFDM) symbol duration or a slot duration;
determining a basic time duration based on the time domain parameter;
time-dividing the basic time duration to determine the time durations; and
allocating each of the time durations to each of the protocol stack entities.

15. The NCR of claim 12, wherein the at least one modem operates based on a clock signal corresponding to an integer multiple frequency of a channel bandwidth.

16. The NCR of claim 12, wherein in the providing of the communication service to each terminal, the at least one processor causes the NCR to perform:
receiving, from the base station, a specific radio network temporary identifier (RNTI) for each of the generated plurality of virtual NCRs;
receiving, from the base station, the access link beam indication for each of the plurality of virtual NCRs based on the specific RNTI; and
providing, by using each of the plurality of virtual NCRs, the communication service to each terminal through the access link beam based on the access link beam indication.

17. The NCR of claim 16, wherein in the receiving of the specific RNTI for each of the generated plurality of virtual NCRs, the at least one processor causes the NCR to perform:
transmitting, to the base station, a preamble sequentially by using each of the plurality of virtual NCRs; and
receiving, from the base station, the specific RNTI for each of the plurality of virtual NCRs.

18. The NCR of claim 12, wherein each of the protocol stack entities performs a function of at least one layer among a medium access control (MAC) layer, a radio link control (RLC) layer, a packet data convergence protocol (PDCP) layer, a radio resource control (RRC) layer, a non-access stratum (NAS) layer, and an upper part of a physical (PHY) layer.
